(19) United States
(12) Patent Application Publication
(10) Pub. No.: US 2006/0093460 A1
(43) Pub. Date: May 4, 2006

(54) Model vehicle air cleaner nut

(76) Inventor: Robert D. Walker, Chesterfield Township, MI (US)

Correspondence Address: GREGORY T. ZALECKI, 12900 HALL ROAD, SUITE 400, STERLING HEIGHTS, MI, 48313, US

(21) Appl. No.: 10/981,313

(22) Filed: Nov. 4, 2004

(51) Int. Cl. F02N 3/00

(52) U.S. Cl. 411/427

(57) ABSTRACT

A model vehicle air cleaner nut comprising a threaded stem, a mounting plate and a model vehicle. The threaded stem has an opening at one end. It is shaped and sized to thread onto a threaded air cleaner mounting stud. The mounting plate is attached to the other end of the threaded stem. The plane of the mounting plate is substantially perpendicular to the longitudinal axis of the threaded stem. A model vehicle is attached to the mounting plate. The nut secures an air cleaner cover to an air cleaner housing by threading onto a mounting stud which projects through the housing and cover.

### BACKGROUND

Most automobiles are powered by internal combustion engines which have air cleaner assemblies. The air cleaner assemblies contain air filters. The purpose of the air filter is to filter particulates from the air before that air is introduced into the engine. This is necessary in order to minimize wear upon the drivetrain parts of the engine which would otherwise occur if contaminated air were introduced into the combustion chambers of the engine. Air filtering is also necessary to maintain the cleanliness and operability of the air induction system of the engine.

The primary parts of an air cleaner assembly are an air cleaner housing, an air cleaner cover and an air filter. The housing and the cover form a container which encloses the filter. Unfiltered air passes into an inlet of the assembly. Filtered air passes out of an outlet of the assembly into the engine. A mounting stud is attached to the engine. The mounting stud passes through the air cleaner housing and the air cleaner cover. The cover is secured to the housing with a wing nut attached to the stud. The wings on the wing nut extend radially from the axis passing through the center of the nut. The wings are necessary for allowing sufficient torque to be applied to the wing nut by hand to securely attach the air cleaner cover to the air cleaner housing. A fastener, such as a wing nut, is a necessary part for most air cleaner assemblies.

Most car owners have pride in their vehicles. This is especially true for classic car owners. Classic car owners often look for ways to make their vehicles unique and memorable to others. For example, classic cars often have multiple chrome plated engine parts. These include chrome plated air cleaner housings and chrome plated air cleaner covers. Classic car owners also often desire to display miniature replica models of their vehicles. There is a need for a fastener which will secure an air cleaner cover to an air cleaner housing and also display a model vehicle on top of the fastener in such a way that the model vehicle can be used to apply tightening torque to the fastener by hand.

### SUMMARY

A conventional air cleaner assembly for use on a motor vehicle is comprised of an air cleaner housing, an air cleaner cover, an air filter, a mounting stud and a wing nut. The mounting stud is attached to the engine of the vehicle. The mounting stud is threaded. The air cleaner cover is positioned on top of the air cleaner housing, forming a container. The air filter is positioned within the container formed by the cover and the housing. The mounting stud projects through the housing and an opening within the air cleaner cover. The wing nut is screwed onto the mounting stud to secure the air cleaner cover to the air cleaner housing.

A model vehicle air cleaner nut is used to secure an engine air cleaner cover to an engine air cleaner housing. It is comprised of a threaded stem and a model vehicle. The threaded stem has an opening at one end. The threaded stem and opening are shaped and sized to thread onto a threaded air cleaner mounting stud. The model vehicle is attached to the other end of the threaded stem. It is attached such that the longitudinal axis of the model vehicle is substantially perpendicular to the longitudinal axis of the threaded stem. The ends of the model vehicle perform a function similar to the wings on a conventional air cleaner wing nut. They facilitate hand application of tightening torque to the threaded stem for tightening the stem onto the mounting stud.

The model vehicle may be attached to the threaded stem with a mounting plate. In this configuration, a mounting plate is attached to the other end of the threaded stem, rather than the model vehicle being directly attached to the threaded stem. The plane of the mounting plate is substantially perpendicular to the longitudinal axis of the threaded stem. The model vehicle is attached to the mounting plate.

Additional enhancements of the model vehicle air cleaner nut are preferred. The cross-sectional area of the end of the threaded stem having an opening at one end should be enlarged. This will provide a larger contact area between the threaded stem and the air cleaner cover. The larger contact area permits the nut to be used with air cleaner covers having larger openings. The side of the air cleaner cover proximal to the threaded stem should have a mirrored finish. Preferably, the mirrored finish is comprised of chrome plating. The mirrored finish will display the underside of the model vehicle to an observer looking within the engine compartment of the motor vehicle. The model vehicle should be a replica of the motor vehicle within which the model vehicle air cleaner nut is used. Not only does this permit a motor vehicle owner to demonstrate his or her pride in the vehicle, it allows a person looking into the engine compartment to identify the motor vehicle containing the engine.

### DRAWINGS

These and other features, aspects, and advantages of the present invention will become better understood with regard to the following description, appended claims, and accompanying drawings where:

FIG. 1 is a perspective view of an air cleaner cover secured to an air cleaner housing with a model vehicle air cleaner nut.

FIG. 2 is an exploded perspective view of a model vehicle air cleaner nut having a mounting plate.

FIG. 3 is side elevation view of the model vehicle air cleaner nut of FIG. 2.

FIG. 4 is a side elevation view of another version of a model vehicle air cleaner nut wherein the underbody of the model vehicle and the threaded stem are one integral piece.

FIG. 5 is a sectional side elevation view of a model vehicle air cleaner nut, wherein the threaded stem and the model vehicle are one integral piece.

FIG. 6 is a perspective view of a vehicle with its hood open to display an air cleaner assembly having its cover secured to its housing by a model vehicle air cleaner nut.

### DESCRIPTION

A model vehicle air cleaner nut a 32 is a fastener used on an air cleaner assembly 20 of a motor vehicle 22. The motor vehicle 22 upon which the invention is used is typically an automobile, a sport utility vehicle or a pickup truck. Often the motor vehicle 22 is a classic car such as a 40-year-old well-known vehicle which has been repaired and maintained to appear as a relatively newer vehicle.

The simplest version of a model vehicle air cleaner nut 32 is comprised of a threaded stem 34 and a model vehicle 46. The model vehicle air cleaner nut 32 is used to secure an air cleaner cover 26 to an air cleaner housing 24. The air cleaner housing 24 has an opening at its top. The air cleaner cover 26 is positioned on top of the air cleaner housing 24 to form a container. The container holds an air filter. A threaded mounting stud 30 is attached to the engine of the motor vehicle 22 in the proximity of the air induction system of the engine. The threaded mounting stud 30 projects through the air cleaner housing 24 and an opening within the air cleaner cover 26. The air cleaner cover 26 is secured to the air cleaner housing 24 by screwing and tightening the model vehicle air cleaner nut 32 onto the end of the threaded mounting stud 30 which projects through the air cleaner cover 26.

The threaded stem 34 has internal threads 36. The threads 36 of the threaded stem 34 are adapted to mate with the threads of the mounting stud 30. The threaded stem 34 has an opening 38 at one of its ends. The other end of the threaded stem 34 may also be open. The opening 38 of the threaded stem 34 exposes the threads 36 of the threaded stem 34. The opening 38 of the threaded stem 34 facilitates the insertion and mating of the mounting stud 30. Preferably, the threaded stem 34 is fabricated from cold rolled steel. It may be fabricated from any rigid maternal capable of being threaded such as plastic or nylon. The threaded stem 34 should be chrome plated or painted silver to enhance its appearance. Cold rolled steel provides a good base for chrome plating. Another ideal material from which the threaded stem 34 may be fabricated is stainless steel because of the similarity between a threaded stem 34 with a stainless steel surface and a threaded stem 34 fabricated from cold rolled steel which has been chrome plated.

The threaded stem 34 may be provided with a thread adapter. Not all mounting studs 30 on currently used vehicles have the same outside diameter. The thread adapter is cylindrically shaped to fit within the opening 38 of the threaded stem 34. The thread adapter has external threads which mate with the internal threads 36 of the threaded stem. The thread adapter has a hollow opening along its longitudinal axis provided with internal threads. The internal threads of the thread adapter and are configured to mate with the threads of a mounting stud 30 having a smaller diameter. If the diameter of the internal threads 36 of the threaded stem 34 is too large to fit the mounting stud 30, the thread adapter is screwed into the internal threads 36 of the threaded stem 34 to provide the threaded stem 34 with internal threads 36 which fit the smaller diameter mounting stud 30.

The model vehicle 46 is a miniature version of a motor vehicle. Preferably, it is constructed from plastic or steel. Ideally, it is a scale model of a well-known classic vehicle. The body detailing, underside configuration, wheels, tires and surface painting should match that of the well-known classic car being emulated.

The model vehicle 46 is attached to the other end of the threaded stem 34. The model vehicle 46 is attached to the threaded stem 34 such that the longitudinal axis of the model vehicle 46 is substantially perpendicular to the longitudinal axis of the threaded stem 34. The model vehicle 46 permits hand applied tightening torque to be applied to the threaded stem 34 when the threaded stem is screwed onto the mounting stud 30.

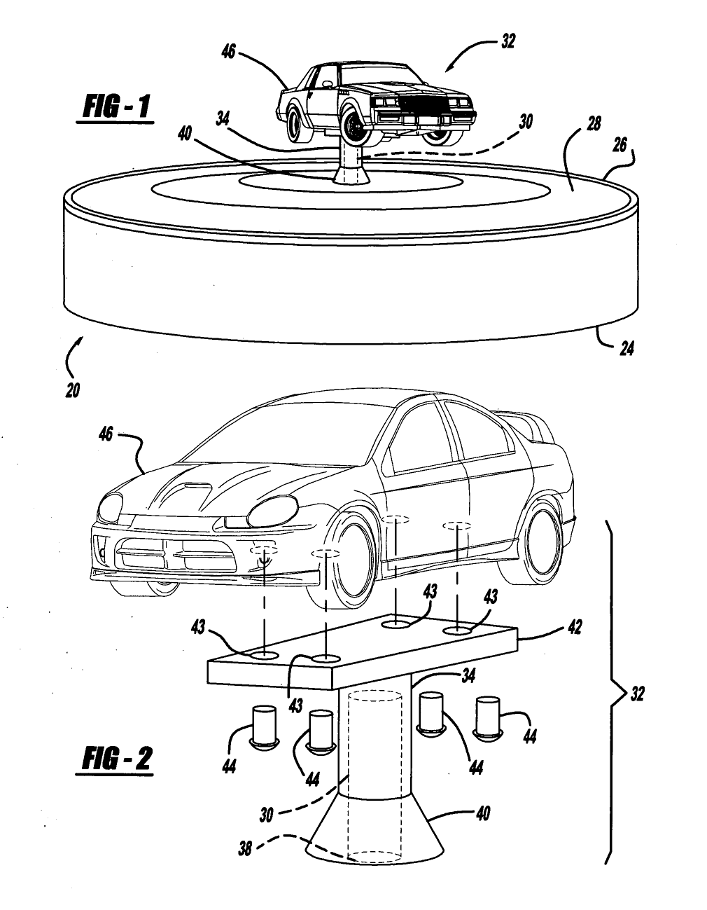

In the preferred embodiment of the motor vehicle air cleaner nut 32, a mounting plate 42 is attached to the threaded stem 34 and the model vehicle 46 is attached to the mounting plate 42, as shown in FIG. 2. The mounting plate 42 is attached to the other end of the threaded stem 34. This is the end of the threaded stem 34 which is opposite the opening 38 which receives the threaded mounting stud 30. The mounting plate 42 has a plurality of openings 43 for receiving fasteners 44. The fasteners 44 may be rivets or screws. The fasteners 44, as well as the mounting plate 42, should be chrome plated or painted silver to enhance the appearance of those parts. Alternatively, the mounting plate 42 and the fasteners 44 may be fabricated from stainless steel to provide an appearance comparable to that of chrome plating. The mounting plate 42 is attached to the threaded stem 34 such that the plane of the mounting plate 42 is substantially perpendicular to the longitudinal axis of the threaded stem 34. The model vehicle 46 is attached to the mounting plate 42 by the fasteners 44. The fasteners 44 pass through the fastener openings 43 within the mounting plate 42 and attach to the underside of the model vehicle 46. The mounting plate 42 should be constructed from the same material from which the threaded stem 34 is fabricated. In this configuration the model vehicle 46 also permits hand applied tightening torque to be applied to the threaded stem 34 when the threaded stem is screwed onto the mounting stud 30.

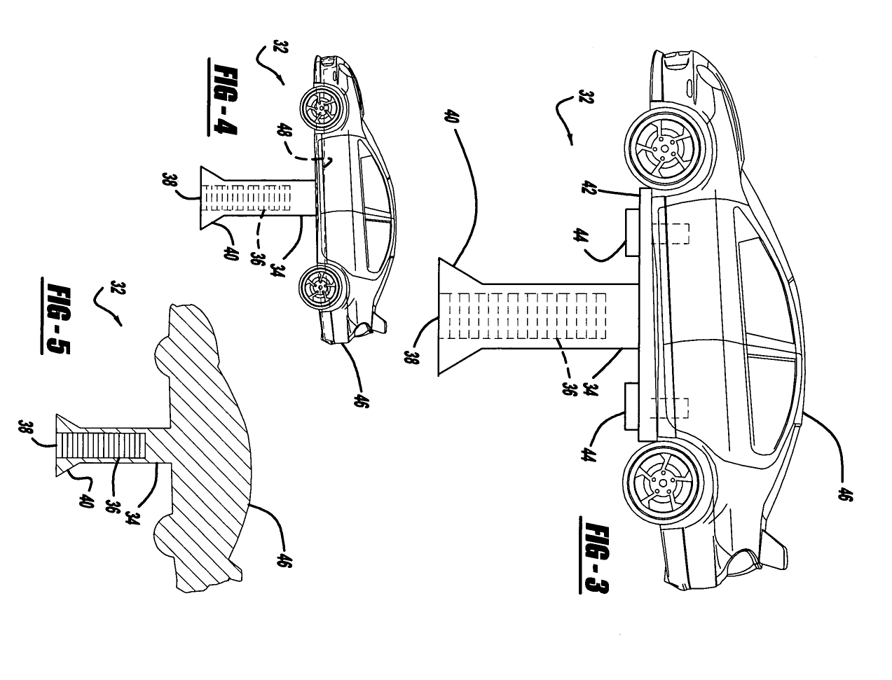

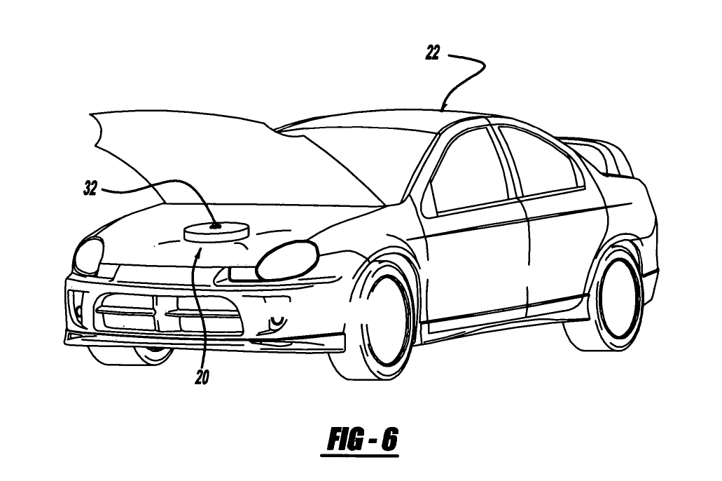

FIGS. 3-5 show three embodiments of a model vehicle air cleaner nut 20. FIG. 3 shows a threaded stem 34 attached to a mounting plate 42. The mounting plate 42 is secured to the model vehicle 46 with a plurality of fasteners 44. FIG. 4 shows a typical two-piece model vehicle 46. The model vehicle 46 has an underbody 48. The underbody 48 has underbody detailing, tires and wheels. The underbody 48 may be press fit to the model vehicle 46 or the underbody 48 may be secured to the model vehicle with fasteners. The embodiment of FIG. 4 has a threaded stem 34 which is integral with the underbody 48. This may be accomplished by molding the underbody 48 and the threaded stem 34 as one piece. In FIG. 5 the threaded stem 34 and the model vehicle 46 are one integral piece. This may be accomplished by molding the model vehicle 46 and the threaded stem 34 as one piece.

The cross-sectional area of the end of the threaded stem 34 having an opening 38 at one end should be enlarged, as shown in FIG. 2. The enlarged open end 40 of the threaded stem 34 will provide a larger contact area between the threaded stem 34 and the air cleaner cover 26. The larger contact area permits the model vehicle air cleaner nut 32 to be used with air cleaner covers 26 having larger mounting stud openings.

Another version of the invention is an air cleaner assembly 20 for use on a motor vehicle 22. The air cleaner assembly 20 is comprised of an air cleaner housing 24, an air cleaner cover 26, a threaded mounting stud 30 and a model vehicle air cleaner nut 32 as described above. The air cleaner housing 24 is a conventional air cleaner housing having an opening at its top, an air inlet and an air outlet. The air cleaner housing 24 is shaped to hold an air filter. The air cleaner cover 26 is positioned on top of the air cleaner housing 24. This forms a container for holding the air filter. One end of the threaded mounting stud 30 is attached to the vehicle engine in proximity to the air induction system of the engine. The other end of the threaded mounting stud 30 projects through the air cleaner housing 24 and an opening within the air cleaner cover 26. The threaded stem 34 of the model vehicle air cleaner nut 32 is threaded onto the threaded mounting stud 30 such that the air cleaner cover 26 is secured to the air cleaner housing 24.

Preferably, the side of the air cleaner cover 26 which is proximal to the threaded stem the 34 of the model vehicle air cleaner nut 32 should have a mirrored finish 28. Preferably, the mirrored finish 28 is comprised of chrome plating. The air cleaner cover 26 may be chrome plated using a conventional process. The mirrored finish 28 will display the underside of the model vehicle 46 to an observer looking within the engine compartment of the motor vehicle 22. The model vehicle 46 should be a replica of the motor vehicle 22 within which the model vehicle air cleaner nut 32 is used. For example, if the model vehicle air cleaner nut 32 is used within a certain classic car, the model vehicle 46 attached to the threaded stem 34 of the model vehicle air cleaner nut 32 should replicate the classic car as closely as possible. Not only does this permit a motor vehicle owner to demonstrate his or her pride in the vehicle, it allows a person looking into the engine compartment to identify the motor vehicle containing the engine being observed.

The model vehicle air cleaner nut 32 is used in the same manner that a conventional wing nut is used to secure an air cleaner cover 26 to an air cleaner housing 24. The air cleaner housing 24 is positioned over the threaded mounting stud 30 onto the engine. An air filter is placed within the air cleaner housing. The air cleaner cover 26 is positioned on top of the air cleaner housing 24 such that the opening within the air cleaner cover 26 has the threaded mounting stud 30 pass through it. Thus the air cleaner cover 26 and the air cleaner housing 24 form a container which holds the air filter. The threaded stem 34 of the model vehicle air cleaner nut 32 is threaded onto the mounting stud 30 and tightened by grasping the model vehicle 46 and turning it. The model vehicle air cleaner nut 32 is tightened sufficiently to secure the air cleaner cover 26 to the air cleaner housing 24. Upon completion of this process the air cleaner cover 26 seals the air filter within the air cleaner housing 24 and the model vehicle 46 is proudly displayed to anyone inspecting the engine compartment of the motor vehicle 22, as shown in FIG. 6.

Although the invention has been shown and described with reference to certain preferred embodiments, those skilled in the art undoubtedly will find alternative embodiments obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. A model vehicle air cleaner nut for securing an air cleaner cover to an air cleaner housing, said model vehicle air cleaner nut having:
(a) a threaded stem having an opening at one end, said threaded stem and opening being shaped and sized to thread onto a threaded air cleaner mounting stud; and
(b) a model vehicle attached to the other end of the threaded stem such that the longitudinal axis of the model vehicle is substantially perpendicular to the longitudinal axis of the threaded stem.

2. The model vehicle air cleaner nut of claim 1, wherein the cross-sectional area of the end of the threaded stem having an opening at one end is enlarged.

3. A model vehicle air cleaner nut for securing an air cleaner cover to an air cleaner housing, said model vehicle air cleaner nut comprising:
(a) a threaded stem having an opening at one end, said threaded stem and opening being shaped and sized to thread onto a threaded air cleaner mounting stud;
(b) a mounting plate attached to the other end of the threaded stem, the plane of said mounting plate being substantially perpendicular to the longitudinal axis of the threaded stem; and
(c) a model vehicle attached to the mounting plate.

4. The model vehicle air cleaner nut of claim 3, wherein the cross-sectional area of the end of the threaded stem having an opening at one end is enlarged.

5. An air cleaner assembly for use on a motor vehicle, said air cleaner assembly comprising:
(a) an air cleaner housing having an opening at its top;
(b) an air cleaner cover positioned on top of the air cleaner housing to form a container for holding an air filter;
(c) a threaded mounting stud projecting through the air cleaner housing and an opening within the air cleaner cover;
(d) a threaded stem having an opening at one end, said threaded stem and opening being shaped and sized to thread onto the air cleaner mounting stud; and
(e) a model vehicle attached to the other end of the threaded stem such that the longitudinal axis of the model vehicle is substantially perpendicular to the longitudinal axis of the threaded stem, the threaded stem being threaded onto the mounting stud such that the air cleaner cover is secured to the air cleaner housing.

6. The air cleaner assembly of claim 5, wherein the cross-sectional area of the end of the threaded stem having an opening at one end is enlarged.

7. The air cleaner assembly of claim 5, wherein the side of the air cleaner cover proximal to the threaded stem has a mirrored finish for displaying the underside of the model vehicle.

8. The air cleaner assembly of claim 7, wherein the mirrored finish is comprised of chrome plating.

9. The air cleaner assembly of claim 5, wherein the model vehicle is a replica of the motor vehicle.

10. The air cleaner assembly of claim 6, wherein the model vehicle is a replica of the motor vehicle.

11. The air cleaner assembly of claim 7, wherein the model vehicle is a replica of the motor vehicle.

12. The air cleaner assembly of claim 8, wherein the model vehicle is a replica of the motor vehicle.

13. The model vehicle air cleaner nut of claim 1, wherein the threaded stem and the model vehicle are one integral piece.

14. The air cleaner assembly of claim 5, wherein the threaded stem and the model vehicle are one integral piece.

15. The air cleaner assembly of claim 7, wherein the threaded stem and the model vehicle are one integral piece.

16. The air cleaner assembly of claim 8, wherein the threaded stem and the model vehicle are one integral piece.

17. The air cleaner assembly of claim 9, wherein the threaded stem and the model vehicle are one integral piece.

18. The air cleaner assembly of claim 11, wherein the threaded stem and the model vehicle are one integral piece.

19. The air cleaner assembly of claim 12, wherein the threaded stem and the model vehicle are one integral piece.
